(19) United States
(12) Patent Application Publication
(10) Pub. No.: US 2001/0004588 A1
(43) Pub. Date: Jun. 21, 2001

(54) Device and method of transmitting SOS signals in mobile telecommunication terminal

(75) Inventor: Seong-Beom Hong, Cheju-shi (KR)

Correspondence Address: Paul J. Farrell, Esq., DILWORTH & BARRESE, 333 Earle Ovington Boulevard, Uniondale, NY, 11553, US

(73) Assignee: Samsung Electronics Co., Ltd.

(21) Appl. No.: 09/737,409

(22) Filed: Dec. 15, 2000

(30) Foreign Application Priority Data
Dec. 16, 1999 (KR) 1999-58185

(51) Int. Cl. H04M 11/00; H04Q 7/20; H04B 7/00

(52) U.S. Cl. 455/404; 455/521; 340/904

(57) ABSTRACT

Disclosed are a device and a method of transmitting SOS signals in a mobile telecommunication terminal. The method according to the invention includes the steps of converting each of a plurality of SOS phrases stored in the mobile telecommunication terminal with code signals of a corresponding format, and storing the converted codes, providing a user with a menu to select one of the SOS phrases upon entry into an SOS service mode, modulating the code signal of the corresponding format selected by the user from the menu into a frequency of the corresponding bandwidth, and transmitting the modulated signal.

This application claims priority to an application entitled “Device and Method of Transmitting SOS Signals in Mobile Telecommunication Terminal” filed with the Korean Industrial Property Office on Dec. 16, 1999 and assigned Ser. No. 99-58185, the contents of which is hereby incorporated by reference.

### BACKGROUND OF THE INVENTION

1. Field of the Invention

The present invention relates to a device and a method of transmission in a mobile telecommunication terminal, and in particular, to a device and a method of transmitting emergency (SOS) signals.

2. Description of the Related Art

Mobile telecommunication terminals are generally unavailable in “No Service Areas,” which are beyond the reach of the electric waves sent from a base station, such as electric wave dead areas, mountains or oceans. Under certain circumstances that require emergency assistance in an electric dead area or a mountain, etc., the mobile telecommunication terminal is of no use in transmitting SOS signals.

Therefore, if available for transmitting SOS signals in a frequency bandwidth relevant to the area in need, e.g., in the frequency bandwidth used by emergency rescue teams, the mobile telecommunication terminals currently popular and easily accessible by the public can serve as means for requesting rescues in the areas beyond the reach of electric waves sent from a base station.

### SUMMARY OF THE INVENTION

It is, therefore, an object of the present invention to provide a device and a method of transmitting SOS signals from a mobile telecommunication terminal.

It is another object of the present invention to provide a device and a method of requesting emergency assistance in an area beyond the reach of electric waves sent from a base station by converting an SOS message to a format relevant to a mobile telecommunication terminal, storing the formatted message, and transmitting the stored message within a corresponding frequency bandwidth.

It is still another object of the present invention to provide a device and a method of requesting emergency assistance in an area beyond the reach of electric waves sent from a base station by converting an SOS message to a format relevant to a mobile telecommunication terminal, storing the formatted message, and transmitting the stored message within a corresponding frequency bandwidth all accomplished by a simple change of software without any additional hardware.

To achieve the above objects, there is provided a device for transmitting SOS signals from a mobile telecommunication terminal (MTT), comprising: a user interface for providing a menu for selecting from a plurality of SOS phrases stored in the MTT; a memory for storing code signals corresponding to each SOS phrase; a control section for selecting one of the code signals stored in the memory in accordance with a menu selection of the user; a frequency generation section for generating a locally oscillating frequency signal of the corresponding bandwidth; and a frequency modulation section for modulating the selected code signal into a corresponding frequency bandwidth and transmitting the modulated code signal by inputting a locally oscillating frequency signal of the corresponding frequency bandwidth.

To achieve the above objects, there is also provided a method of transmitting SOS signals in a mobile telecommunication terminal, comprising the steps of: converting each of a plurality of SOS phrases stored in the mobile telecommunication terminal into a code signal of the particular format; providing a user with a menu for selecting one of the plurality of SOS phrases upon entry into an SOS mode; modulating a code signal of the particular format selected from the menu by the user into a corresponding frequency bandwidth, and transmitting the modulated code signal.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating a device for transmitting SOS signals in a mobile telecommunication terminal according to an embodiment of the present invention;

FIG. 2 is a block diagram illustrating a mobile telecommunication terminal for transmitting SOS signals according to another embodiment of the present invention; and

FIG. 3 is a flow chart illustrating a process for performing a method for transmitting an SOS signal in a mobile telecommunication terminal according to an embodiment of the present invention.

### DETAILED DESCRIPTION OF THE PREFERRED EMBODIMENT

A preferred embodiment of the present invention will be described herein below with reference to the accompanying drawings. In the following description, same drawing reference numerals represent the same constitutional elements even in different drawings. Also, well-known functions or constructions are not described in detail since they would obscure the invention in unnecessary detail.

According to an embodiment of the present invention, an SOS phrase selected by a user through a user interface is converted into a code signal of a particular format (e.g., a Morse code), and stored in a memory. Or, according to another embodiment of the present invention, an SOS message format converting section may convert a different phrase actually desired by the user (other than those stored in memory) into the particular format. The converted SOS message is modulated into a corresponding high frequency bandwidth, and is transmitted.

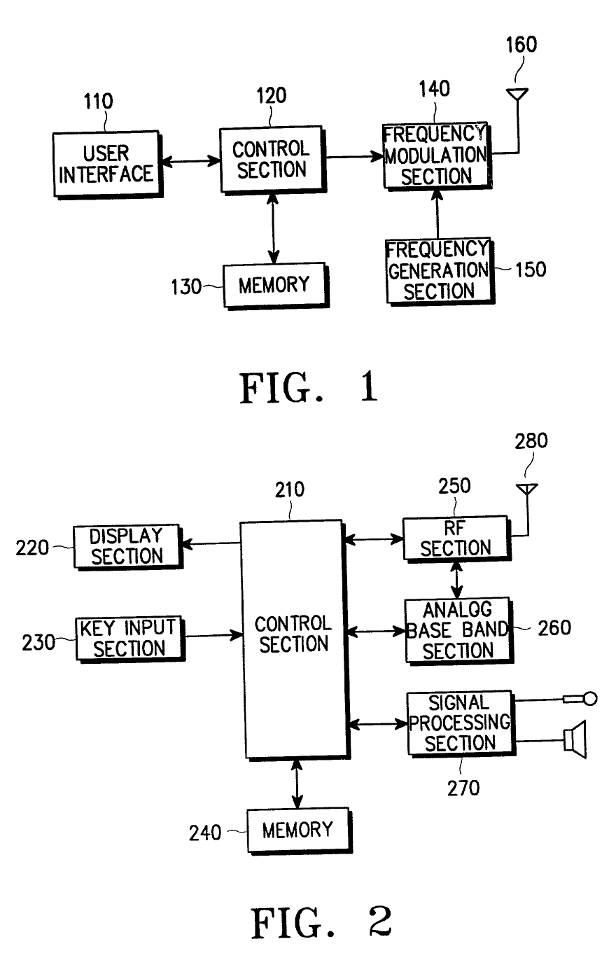

FIG. 1 is a block diagram illustrating a device for transmitting SOS signals in a mobile telecommunication terminal according to an embodiment of the present invention.

A user interface 110 provides an SOS service menu, and outputs to a control section 120 key data corresponding to a menu item selected by the user. The SOS service menu enables the user to select from a plurality of SOS phrases stored in the mobile telecommunication terminal. The SOS service menu may also provide a sentence editing function. A memory 130 stores signals of the code format of each SOS phrase. The code format may be Morse code, for example. The control section 120 selects the signals of the corresponding code format stored in the memory 130 in accordance with the key data input from the user interface 110. A frequency generation section 150 generates a local oscillating frequency of a preselected bandwidth. The frequency generation section 150 may be a voltage controlled oscillator (VCO). Also, the frequency bandwidth may be a frequency bandwidth used by rescue teams, a high frequency (HF) bandwidth, or 3 MHz-30 MHz, to name a few. A frequency modulation section 140 frequency-modulates the code signal output from the control section 120, and outputs the modulated signal through antenna 160.

FIG. 2 is a block diagram illustrating a mobile telecommunication terminal for transmitting SOS signals according to another embodiment of the present invention.

A control section 210 controls the general operation of the mobile telecommunication terminal. A memory 240 comprises storage devices such as a ROM for storing an operative program, an EEPROM for electric programming, a RAM and a flash memory. The memory 240 stores a program for controlling the method of transmitting SOS signals according to an embodiment of the present invention. The memory 240 stores code signals corresponding to each SOS phrase. The code format may be Morse code.

A display section 220 is a display device such as a liquid crystal display (LCD) or a graphic screen. The display section 220 displays the state of the mobile telecommunication terminal or a state of processing the program under a control by the control section 210. The display section 220 also provides an SOS service menu according to the present invention. The user may select any one of a plurality of phrases in the menu stored in the mobile telecommunication terminal. The SOS service menu may also provide a sentence editing function.

A key input section 230 comprises a plurality of numeric keys and functional keys for performing diverse functions, and outputs key input data to the control section 210.

An RF section 250 up-converts the signals input from an analog base band section 260, and transmits the converted signals to a base station (not shown) through an antenna 280. The RF section 250 also down-converts the signals received through the antenna 280 under control by the control section 210, and outputs the converted signal to the analog base band section 260. The analog base band section 260 converts the signal input from the RF section 250 to a base bandwidth and a digital signal, and outputs the converted signal to the control section 210. The analog base band section 260 also outputs the signal output from the control section 210 to the RF section 250.

The control section 210 performs a channel demodulation and a channel decoding with respect to the digital signal output from the base band section 260. The control section 210 also outputs the corresponding voice data to a signal processing section 270. The signal processing section 270 decompresses compressed voice data, converts the decompressed data to audible voice signals, and outputs the converted signals to a speaker.

The signal processing section 270 converts the voice signals of the user to voice data, compresses the converted signals, and outputs the compressed signals to the control section 210. The control section 210 performs a channel coding and a channel modulation with respect to the voice data, and transmits the modulated signals to the base station through the RF section 250 and the antenna 280.

The RF section 250 comprises the VCO, and generates a frequency of a wireless frequency bandwidth or an HF bandwidth through a frequency division under a control by the control section 210. The RF section 250 further enables the control section 210 to use a clock speed compatible with the HF bandwidth by feeding back the frequency of the HF bandwidth when the mobile telecommunication terminal operates in an SOS mode. The VCO may generate a signal of a particular frequency to be allotted when the SOS service is launched for the mobile telecommunication terminal.

Comparing the embodiment of FIG. 1 to the device of FIG. 2, in the SOS mode, the combination of the control section 210 and the analog base band section 260 of FIG. 2 are equivalent to the frequency modulation section of FIG. 1, while the VCO included in the RF section 250 is equivalent to the frequency generation section of FIG. 1.

In the SOS mode, the control section 210 outputs an SOS menu through the display section 220. The control section 210 further outputs to the analog band base section 260 the code signals corresponding to the key input data in accordance with the selection of a menu item by the user. At this stage, the analog base band section 260 converts the input signals to analog signals of the base bandwidth, and outputs the analog signals to the RF section 250. The RF section 250 subsequently generates a frequency of the HF bandwidth under a control by the control section 210, modulates the analog signals of the base bandwidth into the signals of the HF bandwidth, and transmits them through the antenna 280.

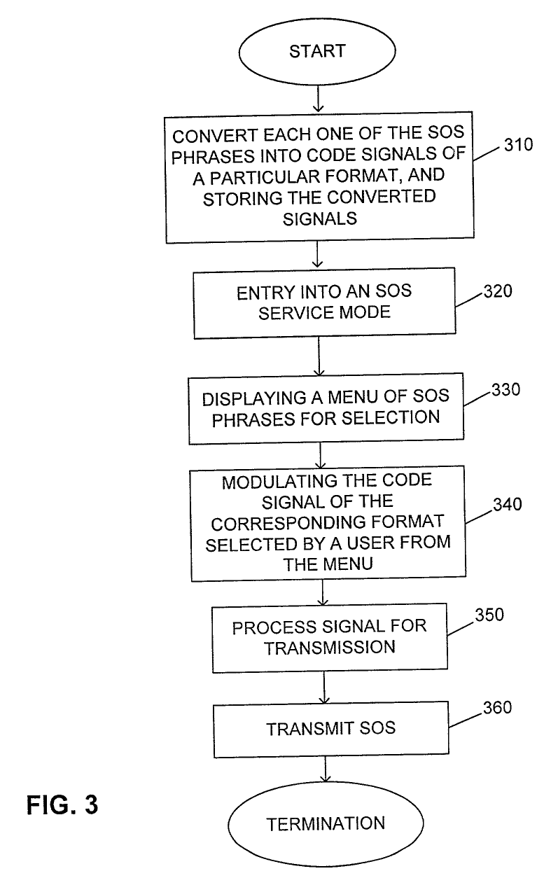

FIG. 3 is a flow chart illustrating a process for performing a method for transmitting an SOS signal in a mobile telecommunication terminal according to an embodiment of the present invention. The method according to an embodiment of the present invention will now be explained with reference to FIG. 2.

In step 310, the control section 210 converts each of the SOS phrases into code signals of the particular format, and stores the SOS phrases ad the corresponding converted signals as a convert table in the memory 240. The format of the code signal may be Morse code. When entering the SOS mode in step 320 by means of an input of the corresponding key data by the user, the control section 210 in step 330 displays on the display section 220 a selection menu of the SOS phrases stored in the memory 210.

In step 340, the control section 210 selects the code signals of the format stored in the memory 240 in accordance with a selection of the menu by the user. The control section 210 then outputs the selected signal to the analog base band section 260. In step 350, the analog base band section 260 converts the selected signal to an analog signal of the base bandwidth, and outputs the converted signal to the RF section 250 under a control by the control section 210. The RF section 250 generates a frequency of the HF bandwidth under a control by the control section 210. The RF section 250 also modulates the analog signal of the base bandwidth to a signal of the HF bandwidth, and in step 360 transmits the modulated signal through the antenna 280. Here, the HF bandwidth may be the frequency bandwidth used by rescue teams. Also, the corresponding bandwidth may be 3 MHz-30 MHz.

While FIG. 3 above exemplified the construction of converting the SOS phrase selected by the user through the user interface to a code signal of the corresponding format (e.g., Morse code) and storing the converted signal in the memory, it is also possible to convert a phrase actually desired by the user in an emergency state to a code signal of the corresponding format by introducing a format converting function of the control section 210, the words inputted by the user being converted to the SOS code by the format converting function.

As described above, the present invention provides an advantage of enabling the user to transmit an SOS message even in the areas beyond reaches of electric waves sent from a base station by converting the SOS message to code signals of a format relevant to a mobile telecommunication terminal, storing the formatted signals and transmitting the stored signals in a corresponding frequency bandwidth.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A device for transmitting SOS signals in a mobile telecommunication terminal, comprising:
a memory for storing code signals of a format corresponding to each of a plurality of SOS phrases;
a user interface for selecting one of the SOS phrases stored in the memory of the mobile telecommunication terminal;
a control section for selecting the stored code signal corresponding to the selection of the user;
a frequency generation section for generating a local oscillating frequency signal of a predetermined bandwidth; and
a frequency modulation section for modulating a frequency of the selected code signal of the corresponding format by inputting the local oscillating frequency signal of the predetermined bandwidth, and transmitting the modulated signal.

2. The device of claim 1, wherein the user interface provides a sentence editing function for editing the SOS phrases.

3. The device of claim 1, wherein the frequency bandwidth is a bandwidth used by rescue teams.

4. The device of claim 1, wherein the frequency bandwidth is a high frequency bandwidth.

5. The device of claim 1, wherein the frequency generation section generates a predetermined frequency allotted for an SOS service in the mobile telecommunication terminal.

6. The device of claim 1, wherein the code of the corresponding format is Morse code.

7. A method of transmitting SOS signals in a mobile telecommunication terminal, comprising the steps of:
converting each of a plurality of SOS phrases stored in the mobile telecommunication terminal to code signals of a corresponding format;
storing the SOS phrases and the corresponding converted codes as a convert table in a memory;
displaying a menu for selecting one of the SOS phrases upon entry into an SOS service mode;
modulating the code signal of the corresponding one of the SOS phrases selected by the user from the menu into a frequency of corresponding bandwidth; and
transmitting the modulated signal.

8. The method of claim 7, wherein the menu of the SOS phrases includes a sentence editing function.

9. The method of claim 7, wherein the frequency bandwidth is a bandwidth used by rescue teams.

10. The method of claim 7, wherein the frequency bandwidth is a high frequency bandwidth.

11. The method of claim 7, wherein the frequency bandwidth is a predetermined frequency allotted for an SOS service in the mobile telecommunication terminal.

12. The method of claim 7, wherein the code of the corresponding format is Morse code.
